(19) United States
(12) Patent Application Publication
(10) Pub. No.: US 2003/0140748 A1
(43) Pub. Date: Jul. 31, 2003

(54) Mat cutter with precision stops

(76) Inventor: Carol E. Hamilton, Prestbury (GB)

Correspondence Address: BRINKS HOFER GILSON & LIONE, ONE INDIANA SQUARE, SUITE 1600, INDIANAPOLIS, IN, 46204-2033, US

(21) Appl. No.: 10/060,629

(22) Filed: Jan. 30, 2002

(51) Int. Cl. B26D 5/00

(52) U.S. Cl. 83/35; 83/391; 83/455; 83/467.1

(57) ABSTRACT

A mat cutter includes a squaring fixture including a locator bar positioned on the work surface by an adjustment element coupled to the locator bar, a driver coupled to the adjustment element, and an electronic control coupled to the driver controlling the power supplied to the driver to locate the locator bar at a desired location relative to a guide bar supporting a manually movable cutting element. Additional adjustment mechanisms are employed to position stops limiting the movement of the cutter element along the guide bar. The adjustment mechanisms for the locator bar and stops are separate from each other, but can be controlled by a common electronic control of intuitive design, and can be uncoupled for fully manual operation.

### BACKGROUND OF THE INVENTION

This invention relates generally to the field of mat board cutters used in the picture framing and related arts, and relates particularly to positioning mechanisms for stops controlling the length of possible displacement of a manually movable cutter head and related mechanisms for locating the mat with respect to the cutter head.

In picture framing, one or more pieces of cardboard usually surrounds a picture between the picture image and the glass and frame or molding that is called a mat board. Mat board cutters are used to cut a mat board to fit within a desired frame and, more importantly, to cut the central sight opening or window, typically rectangular, through which a picture being framed can be viewed. The window is generally cut with a beveled edge of about 45° through the relatively thick mat board. The proper cutting of such windows requires that each cut along each edge for the sight opening start and end at precisely the right position so that the mat board is not “over-cut” or “undercut”. An over-cut results when the cutting blade cuts the mat board beyond a margin forming the desired central sight opening, thus producing a mat that is unsightly and generally not merchantable. An under-cut is wherein the cutting blade does not cut the mat to a desired point, typically defining a corner of the central sight opening, and in removing the waste material to expose the desired sight, unsightly ragged portions remain which must be manually trimmed or sanded, which is usually visible, resulting in an inferior product.

Initially, the windows were cut out using a straight edge and a very sharp edge or razor-type blade, but this operation required a great deal of skill. Mistakes were often made due to inattention or simply lack of skill. About forty years ago the first mat cutting machine was developed, which positioned the mat board on a flat bed with respect to an overlying horizontal shaft. A cutter head holding a razor-type blade at a fixed angle was mounted to the shaft so that the cutter head could be manually moved along the shaft to make a cut in the mat board. Typically, the cutting was done from the back side of the mat and one would mark the starting and stopping points for the four cuts needed to define a given window. While this apparatus substantially reduced the skill required to cut a satisfactory window in a mat, it still required that each mat be individually measured and marked prior to cutting. A few years latter, squaring fixtures were added to the flat bed for engaging an edge of the mat board to assist in locating the mat board at a desired position with respect to the overlying horizontal shaft. Stops were also added to the overlying horizontal shaft that limited the length of movement of the cutter head. The combination of such a squaring fixture and stops permitted one to make a number of identical cuts on a series of mats without marking each mat as disclosed, for example, in Keeton, U.S. Pat. No. 3,213,736 and Broides U.S. Pat. No. 3,779,119.

Somewhat later fine linear graduated scales were added, as were somewhat more versatile stops, to enable precision location of the ends of each movement of the cutter head with respect to an outside edge of the mat board being cut. The stops included indicator markings that were to be used in conjunction with the graduated scales to locate the position of the stop in relation to the scale. A knob coupled to a screw clamp of one type or another could be turned to secure the stop in a desired position as disclosed, for example, in Molpus U.S. Pat. No. 4,036,486 and more recently in Peters, et al., U.S. Pat. No. 5,269,221. With use, however, the scales and indicator markings often became difficult to read due to wear, while repeated use of the clamping mechanism had a tendency to scratch and dig into the shaft holding the stops so that satisfactory positioning becomes increasingly difficult. The digging and scratching is the result of attempts by users of the apparatus to develop sufficient clamping force to withstand the impact to which the stops are repeatedly subjected during normal operation. It has been observed that the constant establishment and maintenance of strong clamping forces tends to overstress and distort the material from which the stop body is fabricated. Such distortion can inhibit full release and free sliding on the shaft, and can ultimately render the clamp completely ineffectual. Indeed, even in the absence of such overstressing stop locking mechanism of the prior art with time often fail to perform satisfactorily and contribute to errors resulting in unmarketable goods.

One solution to this situation is the totally automatic, computer driven mat cutting machines that have been developed by several manufacturers, as disclosed, for example, in Carithers, Jr., U.S. Pat. No. 4,505,174, Busky, et al., U.S. Pat. No. 5,134,911, and Geidl et al., U.S. Pat. No. 5,388,488. The machines can be easily programmed to cut shapes other than mere rectangular windows such as circles, ovals, and various free style figures. These machines are very productive, but very expensive when compared to the cost of the manually operated machines discussed previously. As a consequence, only a few thousand of the totally automatic machines have been sold to large commercial framing houses and companies specializing in pre-cut mats. The totally automatic machines are economically out of the reach of the typical small business frame shops.

Thus, there is a continuing need for a low-cost mat cutting apparatus that will retain its accuracy and reliability even after long-term use. There is also a need for such an apparatus that is easy to learn to use so that training time is minimized, and opportunity for mistakes largely eliminated. Even older and experienced framers often experience deterioration or change in their eyesight with the result that they misread the fine scale markings on manual cutting apparatus and produce more rejected mats. As a result, there is also a need for such an apparatus that eliminates the need to carefully read and interpret fine graduations on scales. There is also a need for a mat-cutting machine that can easily and quickly be modified in function from an assisted machine to a manual machine for certain special operations, and then reconverted back to an assisted machine for more typically operations. There is also a need for a retrofit capability of existing mat-cutting machines.

### SUMMARY OF THE INVENTION

Accordingly, a mat cutter of the present invention includes a generally planar work surface for supporting a mat sought to be cut and a guide bar extending across the work surface that can be spaced from the work surface by a distance sufficient to permit positioning of the mat between the guide bar and the work surface. A carriage is slidably supported upon the guide bar for manual movement relative to the work surface, the carriage including a cutting element for cutting the mat situated on the work surface. Precision stops are provided for limiting the extent of manual movement of the carriage along the guide bar. Each precision stop includes an adjustment member aligned generally parallel to the guide bar. A motor is coupled to the adjustment member for moving the adjustment member relative to the work surface. A contact member is coupled to the adjustment member for positioning by the adjustment member at a selected position for contact by the carriage in a manner limiting the extent of manual movement of the carriage. An electronic control is coupled to the motor for controlling the power supplied to the motor to locate the contact member at a desired location.

The mat cutter of the present invention also includes a squaring fixture including a locator bar positioned on the work surface for engaging an outside edge of the mat to locate the mat relative to the guide bar, and a precision mechanism for positioning the locator bar. The precision mechanism includes an adjustment element coupled to the locator bar. A driver is coupled to the adjustment element for moving the adjustment element relative to the work surface. An electronic control is coupled to the driver for controlling the power supplied to the driver to locate the locator bar at a desired location relative to the guide bar. The adjustment mechanism employed for adjusting the position of the stops and the locator bar are separate from each other, but can be controlled by a common electronic control. A coupling member couples each adjustment mechanism to each corresponding stop or locator bar. The coupling member can be disengaged to permit manual positioning thereof.

In a preferred embodiment of the present invention, the adjustment mechanism employed for adjusting the position of the stops and the locator bar includes a threaded rod that is engaged with a threaded bushing. The coupling member couples the threaded busing to the element sought to be positioned so that rotation of the threaded rod causes linear movement of the relevant member in relation to the work surface. Of course, other adjustment mechanisms can be employed such as a sprocket engaged with a chain or belt, or a pinion gear engaged with a movable rack, or other well-known mechanical equivalents. Further, the motor can be mounted to an element that is either fixed or movable relative to the work surface, and can be mounted directly to an element carrying one of the stops so that activation of the motor causes movement of the motor relative to the working surface.

The motor coupled to the threaded rod or other adjustment mechanism is preferably a stepper motor that is coupled to the electronic control of the present invention. The electronic control can supply a specified number of step pulses to the motor to cause a known amount of rotation of the motor, which is translated by the threaded rod or other adjustment mechanism to a known amount of movement of the one of the positioning elements. A limit switch is mounted at a known position adjacent to the threaded rod and coupled to the electronic control. By moving a positioning element into contact with the limit switch, a known zero or origin position can be specified. Movement of the positioning element relative to this zero or origin position is then simply and easily tracked by tracking the number of pulses delivered to the stepping motor.

The electronic control also preferably includes a keypad for entry of dimensional information. The dimensional information is preferably related to each side of a mat in which a window is to be cut and is stored in a memory unit within the control. Upon activation, the electronic control accesses the stored dimensional entry for one side at a time, and delivers the appropriate number of pulses to the motors coupled to the locator bar and to the stops for moving the related elements to the required position so that a cut can be made. After the operator makes each cut, the operator can select, via the electronic control, a next stored dimensional entry and the process is repeated until all four edges of the window have been cut. It will be appreciated by those skilled in the art that in some circumstances, more than one can be made before it is necessary to select the next stored dimensional entry. In particular, when a number of similar mats are to be cut with the same opening, all of the mats can be serially subjected to a common cutting stroke before moving to the next side of the mat.

A mat cutting machine can be constructed in accordance with the present invention for only a small premium over the cost of a comparable wholly manual machine. Further, the controls of a mat cutting machine of the present invention are easily mastered and require a minimum of training time. Since the desired dimensions are introduced to the electronic controls through a easily read key-pad, there is little chance for error. The electronic recall of the desired dimensions, and motorized movement of the stops to the required positions dramatically speeds the process of cuffing a mat over that of a conventional manual mat cutting machine. The accuracy of an apparatus of the present invention is easily retained since there is no need to visually interpret worn scales or try to compensate for changing or deteriorating eyesight.

Other features and advantages of the present invention will be apparent from the following description of a preferred embodiment of the invention. While the present invention is illustrated in the following discussion in connection with a Fletcher-Terry model 2100 mat cutting machine, the general features of which are depicted in U.S. Pat. Nos. 4,871,156 and 5,161,445, it will be appreciated that the invention can be incorporated in other standard mat cutting machines or can be a feature of a completely new mat cutting device having additional features not illustrated in the accompanying drawings.

### BRIEF DESCRIPTION OF THE DRAWINGS

FIG. 1 is a plan view of a mat cutting apparatus incorporating the features of the present invention.

FIG. 2 is a detail plan view of the input panel for the electronic control of the present invention.

FIG. 3 is a perspective view of the locator bar mechanism including an electronically controlled positioning mechanism of the present invention.

FIG. 3A is a perspective view of a coupling member used to couple the adjustment mechanism to an element sought to be positioned.

FIG. 4 is an elevation view of the positioning mechanism shown in FIG. 3 and the mounting assembly therefore.

FIG. 5 is a detail plan view of one stop mechanism including an electronically controlled positioning mechanism of the present invention.

FIG. 6 is a side elevation view of the stop mechanism shown in FIG. 5.

FIG. 7 is a detail plan view of another stop mechanism including an electronically controlled positioning mechanism of the present invention.

FIG. 8 is a side elevation view of the stop mechanism shown in FIG. 7.

### DESCRIPTION OF THE PREFERRED EMBODIMENTS

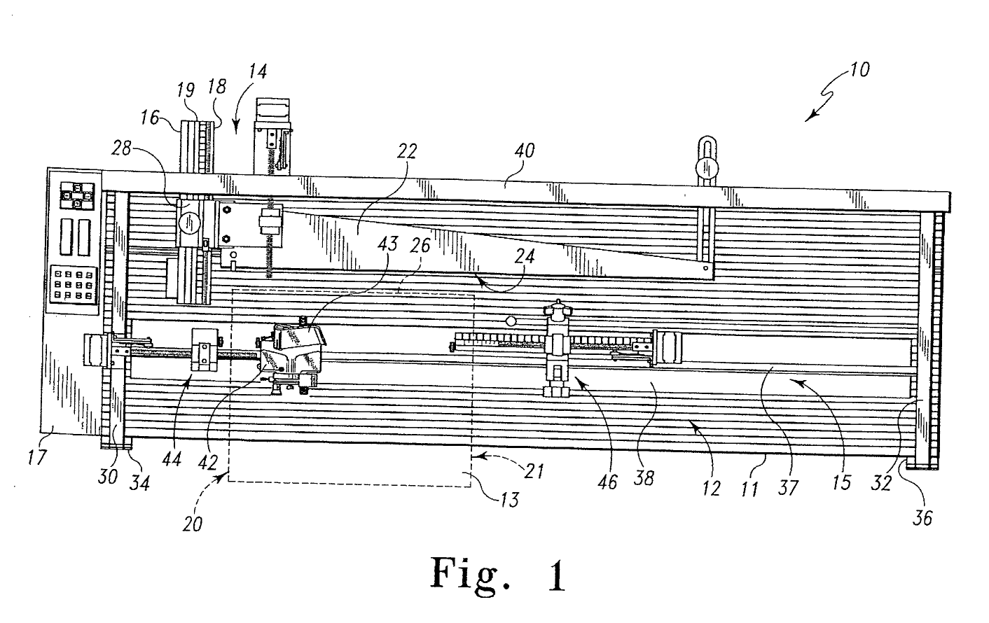

A mat cutter 10 incorporating the present invention is shown in FIG. 1 to include a base 11 having generally planar work surface 12 for supporting a mat 13, which is shown in phantom. The mat cutter 10 also includes a squaring fixture 14, a cutting assembly 15, and an electronic control 17 for controlling the positioning of one portion of the squaring fixture 14 and elements on the cutting assembly 15. The squaring fixture 14 includes a guide plate 16 having an edge 18 intended to come in contact with a first edge 20 of mat 13, and a guide bar 22 having an edge 24 intended to come in contact with a second edge 26 of mat 13. The edges 18 and 24 are maintained at a right angle to each other by a coupling body 28 fixed to guide bar 22 and engaged in an engagement feature such as a groove or land 19 on guide plate 16.

The cutting assembly 15 includes a pair of arms 30 and 32 that are coupled to base 11 by hinges 34 and 36, respectively. A guide bar 38 and a handle bar 40 are fixed to the arms 30 and 32 so that pivotal movement of the handle bar 40 away from the base 11 also causes similar movement of the guide bar 38. The guide bar 38 extends across the work surface 12 and can be raised from the work surface 12 by a distance at least sufficient to permit positioning of the mat 13 on the work surface 12 by lifting upward on handle bar 40. Once the mat is suitably positioned, the handle bar 40 is lowered to clamp the mat 13 between the guide bar 38 and the work surface 12. A carriage 42 is supported upon a rod 37 fixed to the guide bar 38 for manual movement relative to the work surface 12. The carriage 42 includes a cutting element 43 for cutting the mat 13 situated on the work surface 12, the cutting operation being accomplished by depressing the cutting element 43 and then manually moving the carriage 42 along the shaft 37 of the guide bar 38 while maintaining the cutting element 43 in the depressed position. A bottom stop mechanism 44, located at the left of FIG. 1, and a top stop mechanism 46, located at the right of FIG. 1, are provided for limiting the extent of manual movement of the carriage 42 relative to the guide bar 38. The variations in positioning of the stops 44 and 46 in relation to thickness of the mat to be cut is known to those skilled in the art, and can be accommodated by suitable programming of control apparatus 17 of the present invention.

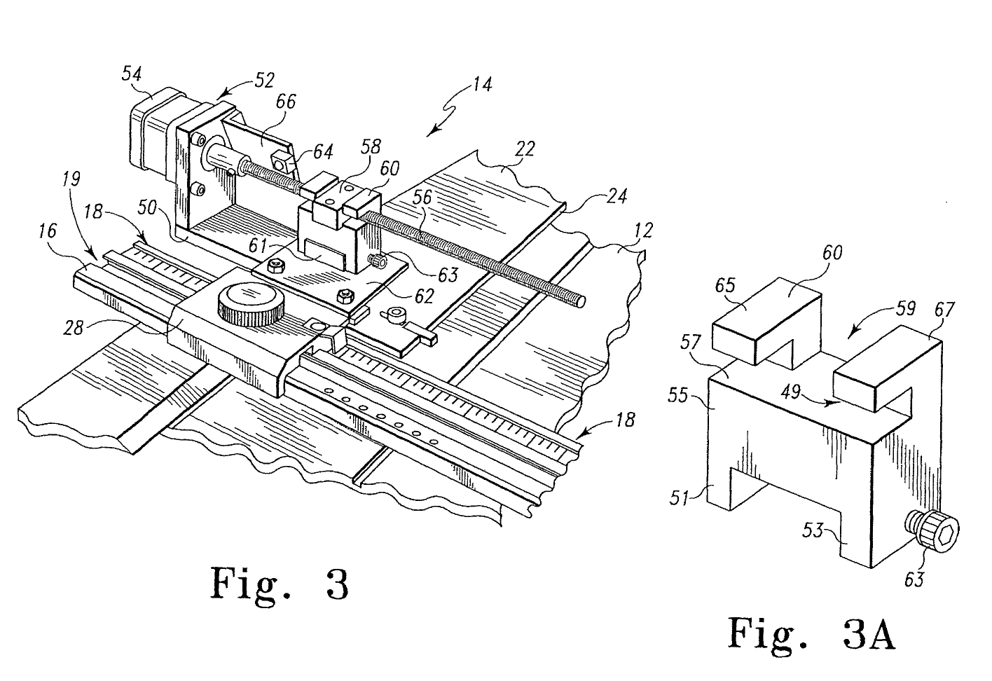

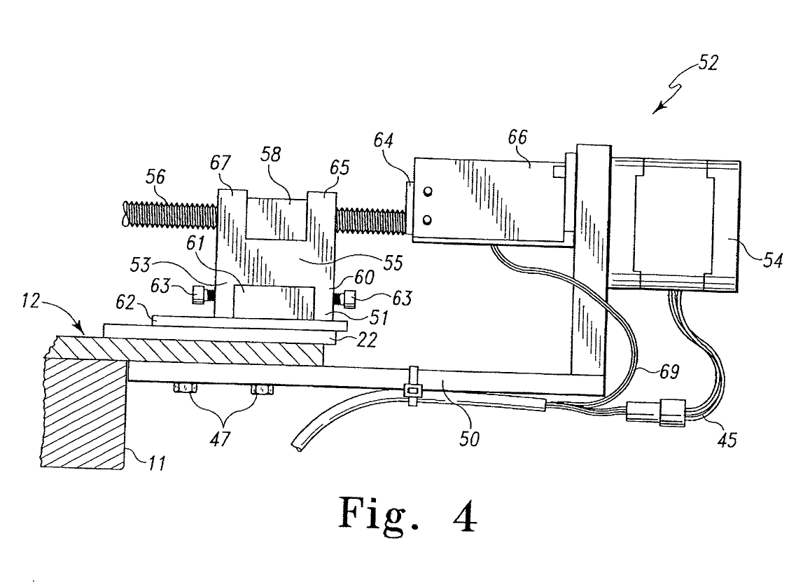

FIGS. 3 and 4 show the squaring fixture 14 of the present invention in greater detail to include a support 50 fixed to the base 11 by fasteners 47. An electronically controlled positioning mechanism 52 is coupled between the support 50 and the coupling body 28 to permit positioning of the edge 24 of guide bar 22 relative to the cutting assembly 15. The positioning mechanism 52 includes a driver in the form of motor 54 fixed to support 50. An adjustment element in the form of a threaded rod 56 is coupled to the motor 54 and extends generally parallel to edge 18 of guide plate 16. A threaded bushing 58 engages rod 56. A coupling member in the form of bracket 60 is coupled to bushing 58 to prevent rotation of the bushing 58 yet permit rotation of the threaded rod 56 within the bushing 58. The bracket 60 is secured to bracket support 62 by threaded fasteners 63. The bracket support 62 is fixed to coupling body 28 that also is fixed to guide bar 22. Any rotation of threaded rod 56 causes a linear displacement of the bushing 58, bracket 60, bracket support 62, coupling body 28 and guide bar 22 in a direction generally parallel to surface 18 of guide plate 16.

The bracket 60 is shown in detail in FIG. 3A to comprise a body 55 having a downward pair of legs 51 and 53 that straddle an upward projection 61 on bracket support 62. A shoulder 57 at an upper portion of body 55 supports a pair of arms 65 and 67 that are spaced apart by an opening 59 dimensioned to receive the threaded bushing 58. The arms 65 and 67 extend over the shoulder 57 to provide an opening 49 of sufficient size to receive the threaded rod 56. The opening 49 permits the bracket 60 to be engaged and disengaged between the threaded bushing 58 and the bracket support 62 by a sliding side-ways motion. This feature permits a mat cutter 10 of the present invention to be easily and quickly converted between a completely manual operation and a semi-automatic operation.

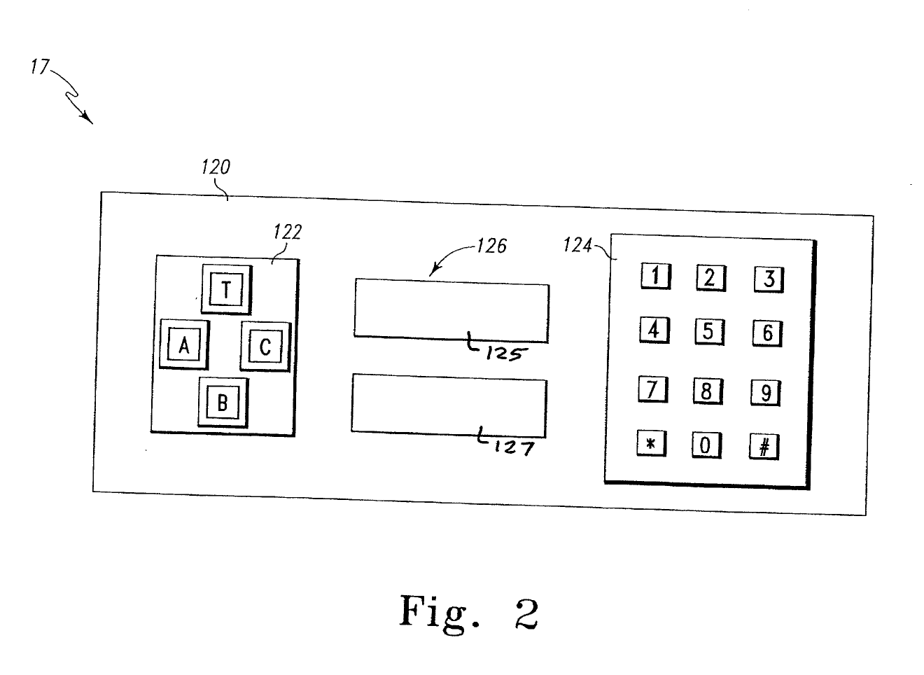

The electronic control 17, shown generally in FIG. 2, is coupled to the stepping motor 54 by wires 45 and controls the power supplied to the stepping motor 54 to locate the locator bar 22 at a desired location relative to the guide bar 38 of the cutting assembly 15. An electronic input device in the form of a limit switch 64 is mounted on sensor support 66 at a known position adjacent to the threaded rod and coupled to the electronic control 17 by wires 69. By moving the combined bushing 58 and bracket 60 into contact with the limit switch 64, a known zero or origin position can be specified. Movement of the combined bushing 58 and bracket 60 relative to this zero or origin position is then simply and easily tracked by the electronic control 17 by tracking the number of pulses delivered from the control 17 to the stepping motor 54. Alternatively, the electronic input device can take the form of an optical reader located on the sensor support 66 adjacent to the positioning mechanism 52. The optical reader can take the form of an LED switch that provides a digital input to a counting circuit within the electronic control 17 via wires 69. The optical reader can sense any rotation of the rod 56 due to the passing of markings, which reflects a change of location of the bushing 58, bracket 60 and related parts fixed to the locator bar 22. The markings can be provided on the rod 56 in the form of longitudinal lines engraved or otherwise placed around the periphery of the rod 58.

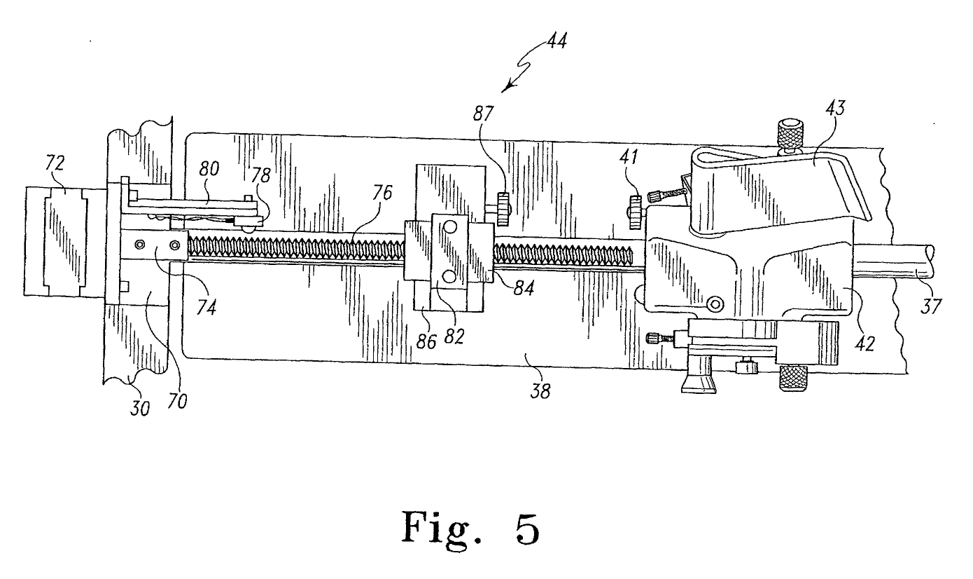

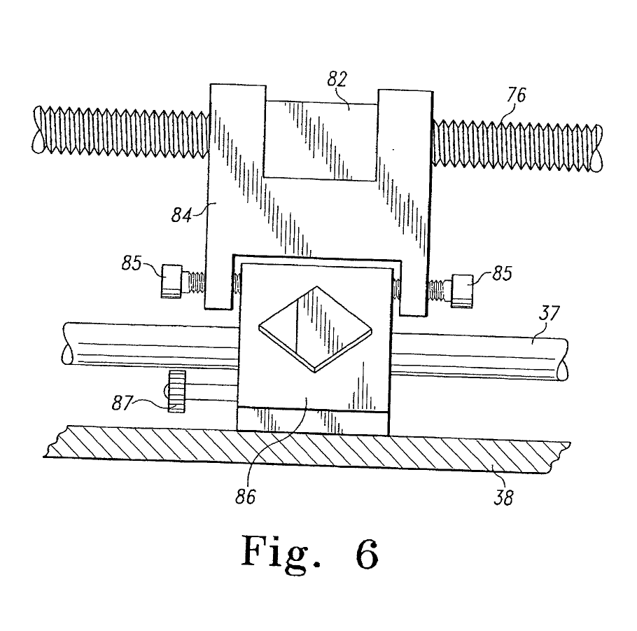

FIGS. 5 and 6 show the bottom stop mechanism 44 is greater detail to include a support 70 fixed to arm 30. A motor 72 is fixed to the support 70 so that the shaft 74 of the motor 72 is aligned generally parallel to rod 37 of the guide bar 38. A threaded rod 76 is coupled to the shaft 74 so that rotation of the motor 72 causes a corresponding rotation of the threaded rod 76. An electronic input device in the form of another limit switch 78 is fixed to the bracket 70 by way of a sensor support 80 so as to be adjacent to the threaded rod 76. A bushing 82 is coupled to the threaded rod 76 and to a bracket 84. Bracket 84 is preferably identical in construction to bracket 60 shown in FIG. 3A. Bracket 84 is releasably coupled to a stop 86 by fasteners 85, as shown in FIG. 6, which artificially enlarges the space between the stop 86 and the bracket 84. The stop 86 is slidably engaged with the guide bar 38. Any rotation of the threaded rod 76 causes a linear displacement of the bushing 82, bracket 84, and stop 86 in a direction generally parallel to rod 37 of guide bar 38. The stop 86 includes a bumper 87 that is designed to confront a similar bumper 41 on carriage 42 to limit the manual displacement of the carriage along the guide bar 38. The electronic control 17, shown generally in FIG. 2, is coupled to the stepping motor 72 and controls the power supplied to the stepping motor 72 to position the stop 86 at a desired location relative to the edge 20 of the mat 13. By moving the combined bushing 82 and bracket 84 into contact with the limit switch 78, a known zero or origin position preferably correlated to the position of edge 18 of guide bar 16, can be specified. The combined bushing 82 and bracket 84 can then be moved relative to this zero position by simply supplying a known number of pulses from the electronic control 17 to the stepping motor 72.

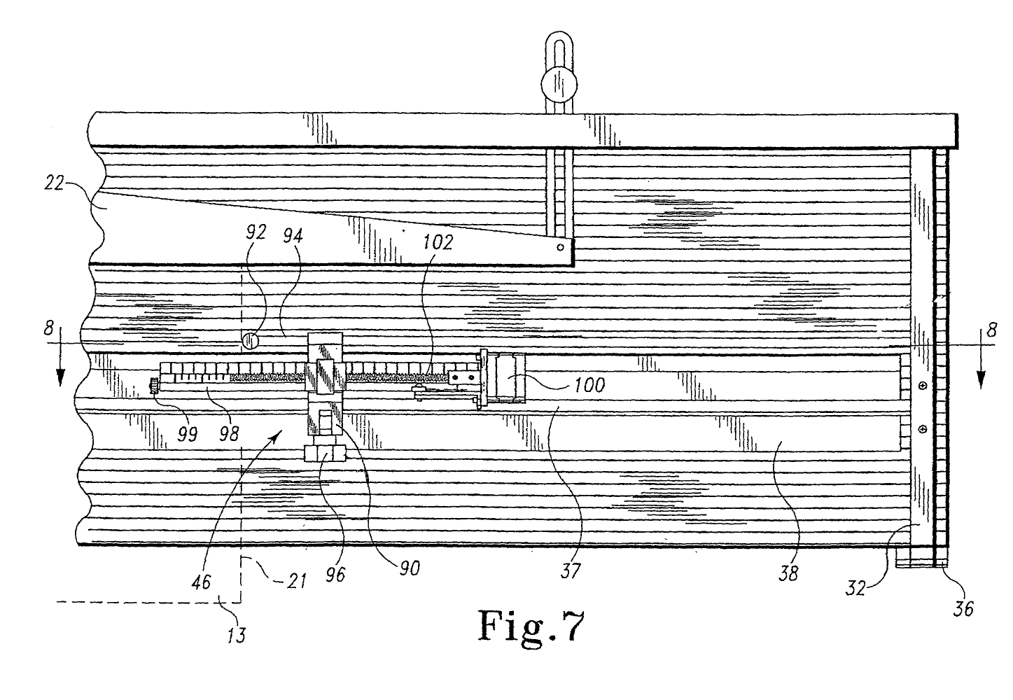

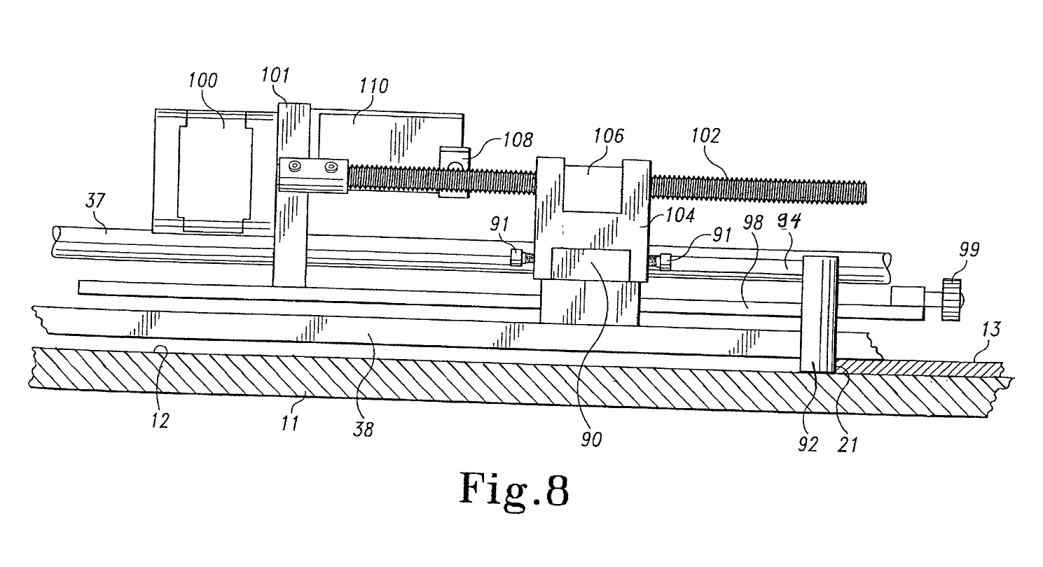

FIGS. 7 and 8 show the top stop mechanism 46 in greater detail to include a body portion 90 slidably mounted on the rod 37 of the guide bar 38. A contact member 92 is fixed to a distal end of an arm 94 of fixed length that is coupled to the body portion 90. The contact member 92 is designed to project downward onto the working surface 12 to engage edge 21 of mat 13 after the mat has been positioned against edge 18 of guide plate 16. A clamping screw can be engaged by manually turning handle 96 to fix the position of body portion 90 with respect to the guide bar 38. The top stop mechanism also includes a movable arm 98 having a bumper 99 on one end of similar function to bumper 87 for limiting the manual displacement of the carriage 42 along the guide bar 38. A stepper motor 100 is fixed to the opposite end of movable arm 98 by support 101 and is coupled to a threaded rod 102 that is aligned parallel to rod 37 of the guide bar 38. A bracket 104, preferably similar in construction to brackets 60 and 84, is fixed to the body portion 90 by fasteners 91 and to a threaded bushing 106 that is engaged on the threaded rod 102.

Any rotation of the threaded rod 102 causes a linear displacement of the motor 100 and movable arm 98 including bumper 99 with respect to body portion 90 in a direction generally parallel to rod 37 of guide bar 38. Another limit switch 108 is located on a sensor support 110 adjacent to the motor 100. Again, the limit switch 108 provides a digital input of a zero position relative to the body portion 90 and contact member 92, which is in contact with the edge 21 of mat 13. A counting circuit within the electronic control 17 counts the pulses delivered to the stepper motor 100 to determine the position of the bumper 99 relative to edge 21. The electronic control 17 can supply any number of pulses to position the bumper 99 at a desired position relative to the edge 21 of the mat 13.

Returning to FIG. 2, the electronic control 17 can include an input control panel 120 that includes a side selection switch set 122, a numerical keypad 124, and an information display 126. The numerical keypad 124 can be a conventional 12-key pad, as shown, or another arrangement if found to be more suitable. The side selection switch set 122 is intended to be intuitive in layout so that the four dimensions of the width between the edge and the window for each side of the mat and be keyed into the memory of the control 17 separately, and can be output from the control 17 to the motors 54, 72 and 100, as necessary. The information display 126 can take any form suitable for displaying the information required for operation of the mat cutter 10 The output from the control 17 to the motors 54, 72 and 100 operates to suitably position the guide bar 22 and the bumpers 87 and 99 for each of the four sides of the mat so that the operator merely needs to turn the mat 13 to the next side to be cut. Once the edges 20 and 26 of the mat are positioned against the edges 18 and 24 of the squaring fixture 14, the body portion 90 is manually moved until contact member 92 engages edge 21 of the mat 13. The body portion is secured in position by turning handle 96. With the correct relative positions of the bumpers having been set by the output from control 17, the only operation remaining for the operator is to manually make the required cut by depressing the cutting element 43 into the mat 13 and then move the carriage 42 along the rod 37 of guide bar 38 between the positions defined by the bumpers 87 and 99.

Power is delivered to the motors 54, 72 and 100 when they are being calibrated or when moving one of the related mechanisms to a desired position. This lowers the power demand of the machine 10 to simply that necessary to operate the computational aspects of the control 17. The information display 126 is preferably arranged as a two-row display. In the preferred embodiment, the upper display window 125 shows information supplied by the controller 17 and either tells the operator where he is in the program or asks for information to be inputted by the operator. The inputted data is shown as keyed-in information in the bottom window 127. One or more of the command buttons of the side selection switch set 122 can be employed during the data input process for correction and control of the information. For example, the C button of the switch set 122 can be used for a “clear” command, and the B button of the switch set 122 can be used for a “back-up” command, etc. The “#” and “*” keys on the keypad 124 can also be used for commands. For example the “*” key can be employed as the decimal point for data input. It will be appreciated that various other arrangements of commands can be employed so that the intuitive nature of the data input and later operation of the machine is optimized. It will also be appreciated at a conventional 16-key keypad or other input unit could be substituted for keypad 124, if required to gain flexibility in the input of information into the control 17.

The control 17 preferably includes a microchip with a memory and an input/output buffer that is controlled by the switch set 122 and keypad 124. In the preferred embodiment, the machine operator can choose and change what ever unit of measurement to that most comfortable or familiar with the operator, e.g., millimeters, centimeters, inches expressed in decimals, inches expressed in fractions, or some other set of units. Additionally, the operator can choose the decimal point to be either a “period” or a “comma” as is common in much of Europe. Further, the control 17 preferably includes an input data error checking routine to make sure that the site specified by the operator is a complete opening, and no side is too long or too short. Further, in the preferred embodiment, the memory is capable of storing a number of previously used data sets, so that the operator can recall all the measurements used in a previous cutting session to re-cut a substitute or replacement mat without having to manually input all of the required measurements.

The proper adjustment for card thickness and blade depth is particularly important to the production of well cut mats. The changes are often considered minor by new-comers to the art, and the rough product produced is often blamed on poor skill in operation of a manual cutter rather than improper computation of the correct dimensions for the cut. To overcome this common fault, the control 17 of the present invention preferably includes the necessary adjustment factors that are required with variation in mat card thickness. This allows the cutting blade to begin and end the cut at precisely the correct location to cause the corners of the site to be properly cut. Even when new cards having a unique thickness are introduced into the machine 10 for the first time, the control 17 can, on the basis of an input thickness measurement, interpolate or extrapolate to provide a best estimate of the correct position for the blade start and finish. In the event that the interpolated or extrapolated values appear to be in error, small adjustments can be made to the program values with the numerical keys of keypad 124, which can, of course, be stored for future use with cards of similar thickness.

As will be appreciated from the attached figures, the three motors 54, 72 and 100, as well as each associated threaded rod, limit switch, threaded bushing and bracket can be of identical construction so that the variety of inventory of parts required to construct a mat cutter according to the present invention is kept to a minimum. The control memory requirements are easily met by inexpensive off the shelf chip based control units so that the overall cost of a mat cutter according to the present invention is only a slight premium over standard manual mat cutters, and is remarkably less that the totally automatic, computer driven mat cutting machines that have been developed. The accuracy of a mat cutter of the present invention is easily retained since there is no need to visually interpret worn scales. Further, the controls of a mat cutting machine of the present invention are easily mastered and require a minimum of training time. Since the desired dimensions are introduced to the electronic controls through a keypads 122 and 124, there is little chance for error. Additionally, it will be appreciated that the various stops and controls of the present invention can be included on mat cutting machines of new construction, and can be retro-fitted on existing equipment as well.

In those circumstances where the operator determines that the electronic control 17 does not provide the necessary freedom of movement, one or more of the brackets 60, 84 and 104 can be disengaged from the corresponding bushing and related structure by loosening the threaded fasteners 63, 85 and /or 91. Once the circumstances permit a return to a control of the mat cutter 10 using the control 17, the brackets 60, 84 and 104 can be easily reinstalled, and recalibrated by bringing each into contact with the corresponding limit switch 64, 78 and 108 to define the zero points for each of the three controls.

While a specific embodiment of the invention has been shown and described herein, the same is merely illustrative of the principles involved and other forms may be resorted to within the scope of the appended claims.

What is claimed is:

1. A precision stop for a mat cutter having a generally planar work surface, a guide bar extending across the work surface, and a carriage slidably supported upon the guide bar for manual movement relative to the work surface, the carriage including a cutting element for cutting a mat situated on the work surface, the precision stop comprising:
an adjustment member aligned generally parallel to the guide bar, a motor coupled to the adjustment member for moving the adjustment member relative to the work surface, a contact member coupled to the adjustment member for positioning by the adjustment member at a selected position for contact by the carriage in a manner limiting the extent of manual movement of the carriage, and an electronic control coupled to the motor for controlling the power supplied to the motor to locate the contact member at a desired location relative to the work surface.

2. The precision stop of claim 1 wherein the adjustment member comprises a threaded rod and the contact member includes a threaded bushing coupled to the threaded rod so that rotation of the threaded rod causes linear movement of the contact member relative to the work surface.

3. The precision stop of claim 1 wherein the electronic control comprises a limit switch located adjacent to the adjustment member for sensing contact with the contact member to provide a reference location input indicative of the location of the contact member.

4. The precision stop of claim 1 further comprising a support for coupling the motor to the guide bar so that movement of the adjustment member can be gauged relative to the guide bar.

5. A mat cutter including a generally planar work surface for supporting a mat sought to be cut, a guide bar extending across the work surface and spaced from the work surface by a distance sufficient to permit positioning of the mat between the guide bar and the work surface, a carriage slidably supported upon the guide bar for manual movement relative to the work surface, the carriage including a cutting element for cutting the mat situated on the work surface, and at least one precision stop for limiting the extent of manual movement of the carriage along the guide bar, each precision stop comprising:
an adjustment member aligned generally parallel to the guide bar, a motor coupled to the adjustment member for moving the adjustment member relative to the work surface, a contact member coupled to the adjustment member for positioning by the adjustment member at a selected position for contact by the carriage in a manner limiting the extent of manual movement of the carriage, and an electronic control coupled to the motor for controlling the power supplied to the motor to locate the contact member at a desired location relative to the work surface.

6. The mat cutter of claim 5 further comprising: a locator bar positioned on the work surface for engaging an outside edge of the mat to locate the mat relative to the guide bar, and a precision mechanism for positioning the locator bar comprising:
an adjustment element coupled to the locator bar, a driver coupled to the adjustment element for moving the adjustment element relative to the work surface, and an electronic control coupled to the driver for controlling the power supplied to the driver to locate the locator bar at a desired location relative to the guide bar.

7. The mat cutter of either of claims 5 or 6 wherein the adjustment member comprises a threaded rod and the contact member includes a threaded bushing coupled to the threaded rod so that rotation of the threaded rod causes linear movement of the contact member relative to the work surface.

8. The mat cutter of claim 6 wherein the adjustment element comprises a threaded shaft and the locator bar includes a threaded follower coupled to the threaded shaft so that rotation of the threaded shaft causes linear movement of the locator bar relative to the work surface.

9. The mat cutter of any of claims 5, 6 or 8 wherein the electronic control comprises a limit switch located adjacent to the adjustment member for sensing contact with the contact member to provide a reference location input indicative of the location of the contact member.

10. The mat cutter of either of claims 6 or 8 wherein the electronic control comprises a limit switch located adjacent to the adjustment element for sensing contact with the contact element to provide a reference location input indicative of the location of the locator bar.

11. The mat cutter of either of claims 6 or 8 further comprising a support for coupling the motor to the guide bar so that movement of the adjustment member can be gauged relative to the guide bar.

12. Apparatus for use in combination with a work surface of a manually operated mat cutter, the apparatus comprising:
a guide bar and a support for coupling the guide bar to a work surface so that the guide bar extends across the work surface and is spaced from the work surface by a distance sufficient to permit positioning of the mat between the guide bar and the work surface, a carriage slidably supported for manual movement along the guide bar, the carriage including a cutting element for cutting a mat situated on the work surface below the guide bar, and at least one precision stop for limiting the extent of manual movement of the carriage along the guide bar, each precision stop comprising:
an adjustment member aligned generally parallel to the guide bar, a motor coupled to the adjustment member and to the support for moving the adjustment member relative to the guide bar, a contact member coupled to the adjustment member for positioning by the adjustment member at a selected position for contact by the carriage in a manner limiting the extent of manual movement of the carriage, and an electronic control coupled to the motor for controlling the power supplied to the motor to locate the contact member at a desired location relative to the guide bar.

13. The apparatus of claim 12 further comprising: a locator bar adapted to be positioned on the work surface for engaging an outside edge of the mat, and a precision mechanism for positioning the locator bar relative to the guide bar comprising:
an adjustment element coupled to the locator bar, a driver coupled to the adjustment element and to said support for moving the adjustment element relative to the guide bar so that the mat is positioned relative to the cutting element carried by the carriage.

14. The apparatus of claim 13 wherein the adjustment member comprises a threaded rod and the contact member includes a threaded bushing coupled to the threaded rod so that rotation of the threaded rod causes linear movement of the contact member relative to the work surface.

15. The apparatus of claim 14 wherein the adjustment element comprises a threaded shaft and the locator bar includes a threaded follower coupled to the threaded shaft so that rotation of the threaded shaft causes linear movement of the locator bar relative to the work surface.

16. The apparatus of claim 15 wherein the electronic control comprises a limit switch located adjacent to the adjustment member for sensing contact with the contact member to provide a reference location input indicative of the location of the contact member.

17. The apparatus of claim 16 wherein the electronic control comprises another limit switch located adjacent to the locator bar adjustment element for sensing contact with the contact element to provide a reference location input indicative of the location of the locator bar.

18. A system for controlling the limits of movement of a manually movable carriage carrying a cutter element on a mat cutter, the mat cutter including a generally planar work surface for supporting a mat sought to be cut, a guide bar extending across the work surface and spaced from the work surface by a distance sufficient to permit positioning of the mat between the guide bar and the work surface, the carriage being slidably supported upon the guide bar for manual movement relative to the work surface, and at least one precision stop for limiting the extent of manual movement of the carriage along the guide bar system, the system comprising:
an adjustment member aligned generally parallel to the guide bar, a motor coupled to the adjustment member for moving the adjustment member relative to the work surface, a contact member coupled to the adjustment member for positioning by the adjustment member at a selected position for contact by the carriage in a manner limiting the extent of manual movement of the carriage, an electronic control coupled to the motor for controlling the power supplied to the motor to locate the contact member at a desired location relative to the work surface, and an input coupled to the electronic control for receiving dimensional information related to a cut to be made with the cutter element.

19. The system of claim 18 further comprising: a locator bar positioned adjacent the work surface for engaging an outside edge of the mat to locate the mat relative to the guide bar, and a precision mechanism for positioning the locator bar comprising:
an adjustment element coupled to the locator bar, a driver coupled to the adjustment element for moving the adjustment element relative to the work surface, and an electronic control coupled to the driver for controlling the power supplied to the driver to locate the locator bar at a desired location relative to the guide bar, and another input coupled to the electronic control for receiving additional dimensional information related to the cut to be made with the cutter element.

20. The system of claim 18 or 19 further comprising a memory unit for storing the dimensional information, and a recall for recalling the dimensional information in at the request of an operator.

21. A method of cutting a window in a mat with a manually operated cutting head comprising the steps of:
providing a motor for each of a plurality of adjustable elements on a mat cutting machine,
providing a control for the motors so that the mat is positioned with respect to the cutting head, and stops are positioned to limit the length of the cut that can be made by the cutting head, and
placing the mat under the cutting head and moving the cutting head the entire length between the stops to make each cut.

22. The method of claim 21 further comprising the step of:
stepping the control for the motors for each side of the window to be cut in a mat until sufficient cuts have been made to fully define the window.
